(19) United States
(12) Patent Application Publication
(10) Pub. No.: US 2024/0172771 A1
(43) Pub. Date: May 30, 2024

(54) NON-LAURIC, NON-TRANS, AND NON-TEMPERING OIL AND/OR FAT FOR CHOCOLATE

(71) Applicant: FUJI OIL HOLDINGS INC., Osaka (JP)

(72) Inventor: Yojiro FUKAMI, Osaka (JP)

(73) Assignee: FUJI OIL HOLDINGS INC., Osaka (JP)

(21) Appl. No.: 18/283,204

(22) PCT Filed: Mar. 29, 2022
(86) PCT No.: PCT/JP2022/015314

§ 371 Date: Sep. 20, 2023

(30) Foreign Application Priority Data
Mar. 31, 2021 (JP) 2021-059675

(51) Int. Cl. A23G 1/36; A23G 1/30

(52) U.S. Cl. CPC A23G 1/36; A23G 1/305

(57) ABSTRACT

The present invention addresses the problem of providing a non-lauric, non-trans, and non-tempering oil and/or fat for chocolate that is less likely to have blooming over a long period of time even in the case of chocolate containing a large amount of cacao components or cocoa butter. The aforementioned problem is solved by incorporating, into a typical non-lauric, non-trans, and non-tempering oil and/or fat for chocolate, a specific amount of a triglyceride bound with one behenic acid, one saturated fatty acid having from 16 to 20 carbons, and one unsaturated fatty acid having from 16 to 20 carbons.

### TECHNICAL FIELD

The present invention relates to a non-lauric, non-trans, and non-tempering oil and/or fat for chocolate.

### BACKGROUND ART

There are roughly two types of oils and/or fats for chocolate that are widely used as cocoa butter alternatives: tempering oils and/or fats for chocolate that are subjected to a temperature control operation during solidification and molding, and non-tempering oils and/or fats for chocolate that are not subjected to a temperature control operation. Tempering oils and/or fats for chocolate contain triglycerides similar to those in cocoa butter as the main component, making them highly compatible with cocoa butter and giving them a texture similar to that of cocoa butter. However, the tempering operation is desirably omitted because it requires strict temperature control.

Meanwhile, non-tempering oils and/or fats for chocolate do not require a complicated tempering operation, and thus can be suitably used in various combination foods in which chocolate is combined with bread, Western-style confectionery, or the like. Non-tempering oils and/or fats for chocolate can be roughly classified into trans fatty acid oils and/or fats for chocolate, interesterified and fractionated oils and/or fats for chocolate, as well as lauric acid oils and/or fats for chocolate.

Among the non-tempering oils and/or fats for chocolate, trans fatty acid oils and/or fats for chocolate, which are obtained by hydrogenating a liquid oil such as soybean oil or rapeseed oil, have good mouth melt and high compatibility with cocoa butter. As such, trans acid oils and/or fats for chocolate have been used widely. However, in recent years, the risk of trans fatty acids on health has become clear, making non-trans fatty acid oils and/or fats for chocolate containing no trans fatty acids desirable.

Lauric acid oils and/or fats for chocolate have long been produced from lauric oils and/or fats rich in triglycerides bound with lauric acid as raw materials. Lauric acid oils and/or fats for chocolate have various advantages, such as having a texture and physical properties that are very similar to those of cocoa butter and having a good shine. However, severe blooming or graining occurs when lauric acid oils and/or fats for chocolate are containing a large amount of cacao components or cocoa butter. In addition, undesirable soapy flavor may develop depending on the storage state of the chocolate, and thus oils and/or fats for chocolate having a reduced lauric acid content are desirable.

As described above, non-trans fatty acid and non-lauric oils and/or fats for chocolate are desirable, and there has been an increased use of interesterified and fractionated oils and/or fats for chocolate in recent years. (Patent Documents 1 to 4). The raw materials of interesterified and fractionated oils and/or fats for chocolate are raw material oils and/or fats with an extremely low lauric acid content or trans fatty acid content, such as fully hydrogenated oil of soybean oil or rapeseed oil, or solid fats such as palm oil. The raw materials are chemically or enzymatically interesterified and then fractionated, giving interesterified and fractionated oils and/or fats good mouth melt.

Compared to lauric acid oils and/or fats for chocolate, the non-lauric, non-trans, and non-tempering oils and/or fats for chocolate as described above have less blooming and graining when blended with a large amount of cacao components or cocoa butter. However, such an effect is insufficient and requires further improvement.

### PRIOR ART DOCUMENTS

### Patent Documents

Patent Document 1: JP 2005-507028 T

Patent Document 2: JP 2010-532802 T

Patent Document 3: JP 2007-319043 A

Patent Document 4: WO 2011/138918

### DISCLOSURE OF THE INVENTION

### Technical Problem

An object of the present invention is to provide a non-lauric, non-trans, and non-tempering oil and/or fat for chocolate that is less likely to have blooming over a wide temperature range and a long period of time even in the case of chocolate blended with a large amount of cacao components or cocoa butter.

### Solution to Problem

As a result of intensive studies to solve the above problems, the present inventor has found that the above problems can be solved by incorporating, into a typical non-lauric, non-trans, and non-tempering oil and/or fat for chocolate, a specific amount of a triglyceride bound with one behenic acid, one saturated fatty acid having from 16 to 20 carbons, and one unsaturated fatty acid having from 16 to 20 carbons, and thus completed the present invention.

That is, the present invention relates to
(1) A non-lauric, non-trans, and non-tempering oil and/or fat for chocolate, the oil and/or fat satisfying all of the following conditions:
a S2U triglyceride content being from 50 to 85 wt. %;
a proportion of SSU triglycerides in S2U triglycerides being from 0.3 to 0.7;
a BSU triglyceride content being from 2 to 15 wt. %;
a ratio of BSU triglycerides to B2U triglycerides (BSU/B2U) being 1 or greater;
a proportion of a total of BSU and B2U triglycerides in a total of B-bound triglycerides being 0.5 or greater;
where “S” means a saturated fatty acid having from 16 to 20 carbons, “U” means an unsaturated fatty acid having from 16 to 20 carbons, “B” means behenic acid, and
“S2U” means a triglyceride bound with two Ss and one U. “SSU” means a triglyceride with S bound at the 2-position and S and U bound at the 1- and 3-positions, “BSU” means a triglyceride bound with one B, one S, and one U. “B2U” means a triglyceride bound with two Bs and one U, and “B-bound triglyceride” means a triglyceride bound with at least one B.
(2) The oil and/or fat for chocolate according to (1), wherein a ratio of BPU triglycerides to BStU triglycerides (BPU/BStU) is 1.5 or greater, where “P” means palmitic acid, “St” means stearic acid, and
“BPU” means a triglyceride bound with one B, one P. and one U, and “BStU” means a triglyceride bound with one B, one St. and one U.
(3) The oil and/or fat for chocolate according to (1), containing from 4 to 20 wt. % of tri-saturated triglycerides.
(4) The oil and/or fat for chocolate according to (2), containing from 4 to 20 wt. % of tri-saturated triglycerides.
(5) The oil and/or fat for chocolate according to any one of (1) to (4), wherein a solid fat content at 20° C. is from 60 to 80%, and a solid fat content at 40° C. is 10% or less.
(6) The oil and/or fat for chocolate according to any one of (1) to (4), wherein the oil and/or fat for chocolate is used in chocolate for coating purposes.
(7) The oil and/or fat for chocolate according to (5), wherein the oil and/or fat for chocolate is used in chocolate for coating purposes.
(8) A chocolate containing the oil and/or fat for chocolate described in any one of (1) to (4).
(9) A chocolate containing the oil and/or fat for chocolate described in (5).
(10) A coating chocolate containing the oil and/or fat for chocolate described in any one of (1) to (4).
(11) A coating chocolate containing the oil and/or fat for chocolate described in (5).

### Advantageous Effects of Invention

The present invention can provide a non-lauric, non-trans, and non-tempering oil and/or fat for chocolate that is less likely to have blooming and that has an excellent solidification speed required for chocolate for coating purposes even in the case of chocolate containing a large amount of cacao components or cocoa butter.

### DESCRIPTION OF EMBODIMENTS

The present invention will be described in detail below.

The term “non-lauric” in the present invention means that lauric oils and/or fats such as coconut oil and palm kernel oil are hardly ever used as raw materials. Specifically, in the fatty acid composition constituting the oil and/or fat for chocolate, the content of fatty acids having from 6 to 12 carbons is less than 5 wt. %, more preferably less than 3 wt. %, still more preferably less than 2 wt. %, and most preferably less than 1 wt. %.

In addition, the term “non-trans” in the present invention means that oils and/or fats containing trans fatty acids such as hydrogenated oils (excluding fully hydrogenated oils) are substantially not used as raw materials. Specifically, the content of trans fatty acids is less than 5 wt. %, and more preferably less than 3 wt. %.

In addition, the term “non-tempering” in the present invention means a type of oil and/or fat for chocolate that, when used to produce chocolate, can provide chocolate by a method of simply cooling and solidifying, without a tempering treatment by adjusting the temperature, adding a seed agent, or the like.

Compared to the typical non-lauric, non-trans, and non-tempering oils and/or fats for chocolate that mainly consist of S2U, the oil and/or fat for chocolate according to an embodiment of the present invention contains B-bound triglycerides as active ingredients in order to improve the blooming resistance and the solidification speed.

The term “B-bound triglycerides” is a collective term for B3, B2S, B2U, BS2, BSU, and BU2 triglycerides. (S represents a saturated fatty acid having from 16 to 20 carbons. U represents an unsaturated fatty acid having from 16 to 20 carbons, and B represents behenic acid.)

Among the B-bound triglycerides, the oil and/or fat for chocolate according to an embodiment of the present invention needs to contain from 2 to 15 wt. % of BSU triglycerides. The oil and/or fat for chocolate according to an embodiment of the present invention preferably contains from 2.5 to 12 wt. %, more preferably from 3 to 10 wt. %, and even more preferably from 4 to 8 wt. % of BSU triglycerides. The content of BSU triglycerides is preferably from 2 to 15 wt. % because the oil and/or fat for chocolate according to an embodiment of the present invention is less likely to have blooming when made into chocolate, and the solidification speed is excellent when the chocolate is used for coating purposes.

A ratio of BPU triglycerides to BStU triglycerides (BPU/BStU), which are categorized as BSU triglycerides, is preferably 1.5 or greater. The ratio is more preferably 2.0 or greater, and even more preferably 2.3 or greater. Here, “P” means palmitic acid and “St” means stearic acid.

A ratio of BSU triglycerides to B2U triglycerides (BSU triglycerides/B2U triglycerides) contained in the oil and/or fat for chocolate according to an embodiment of the present invention needs to be 1 or greater.

The ratio is preferably from 1.5 to 4, and more preferably from 2 to 4. The ratio is preferably 1 or greater because the oil and/or fat for chocolate according to an embodiment of the present invention is less likely to have blooming when made into chocolate, and the solidification speed is excellent when the chocolate is used for coating purposes.

A ratio of the total of BSU and B2U triglycerides to the total of B-bound triglycerides contained in the oil and/or fat for chocolate according to an embodiment of the present invention needs to be 0.5 or greater. The ratio is preferably 0.6 or greater. When the ratio is less than 0.5, the resulting chocolate may have deteriorated mouth melt.

The oil and/or fat for chocolate according to an embodiment of the present invention preferably contains from 4 to 20 wt. %, more preferably from 7 to 17 wt. %, and even more preferably from 10 to 14 wt. % of tri-saturated triglycerides (B3, B2S, BS2, and S3 triglycerides). When the content of the tri-saturated triglycerides is less than 4 wt. %, the chocolate may not have an appropriate hardness. In addition, when the chocolate is used for coating purposes, the solidification speed may be decreased. Meanwhile, when the content is greater than 20 wt. %, the resulting chocolate may have deteriorated mouth melt.

The “S2U triglycerides” contained in the oil and/or fat for chocolate according to an embodiment of the present invention means both SUS triglycerides having S at the 1- and 3-positions and U at the 2-position and SSU triglycerides having S at the 1- and 2-positions and U at the 3-position. The chocolate preferably has a property that it is hard at around room temperature and rapidly melts at around body temperature. In order to give such properties, the content of S2U needs to be from 50 to 85 wt. % wt. %, preferably from 55 to 80 wt. %, and more preferably from 65 to 75 wt. %. When S2U is less than 50 wt. %, the resulting chocolate becomes too soft at room temperature. When S2U exceeds 85 wt. %, the resulting chocolate becomes too hard at room temperature. Both lead to deterioration in texture.

A ratio of SSU triglycerides in the S2U triglycerides contained in the oil and/or fat for chocolate according to an embodiment of the present invention (SSU/S2U) needs to be from 0.3 to 0.7, and is preferably from 0.5 to 0.6. When the ratio is less than 0.3, blooming or graining is likely to occur when the oil and/or fat for chocolate according to an embodiment of the present invention is mixed with cocoa butter. Whereas, when the ratio exceeds 0.7, concentration by interesterification and fractionation of oil and/or fat becomes necessary, and the production cost becomes too high, which is not preferable.

The oil and/or fat for chocolate according to an embodiment of the present invention has a solid fat content at 20° C. of preferably from 60 to 80%, and more preferably from 55 to 75%. In addition, the oil and/or fat for chocolate according to an embodiment of the present invention has a solid fat content at 40° C. of preferably 10% or less, more preferably 6% or less. In addition, the oil and/or fat for chocolate according to an embodiment of the present invention has a solid fat content at 25° C. of preferably from 40 to 60% by weight, and a solid fat content at 30° C. of preferably from 20 to 40%. When the solid fat content is in the above-mentioned preferable ranges, the oil and/or fat for chocolate according to an embodiment of the present invention has good mouth melt when made into chocolate, which is preferable.

The oil and/or fat for chocolate according to an embodiment of the present invention can be produced as an oil and/or fat of a low melting point fraction or a medium melting point fraction by, for example, subjecting a raw material oil and/or fat mixture to random interesterification and then performing a fractionation operation. The oil and/or fat for chocolate according to an embodiment of the present invention can also be produced by preparing a plurality of oils and/or fats of the low melting point fraction or the medium melting point fraction and then mixing these oils and/or fats.

Specific examples of the raw material oil and/or fat include palm oil, rapeseed oil, high erucic rapeseed oil, sunflower oil, high oleic sunflower oil, soybean oil, rice bran oil, corn oil, cottonseed oil, peanut oil, safflower oil, safflower oil, olive oil, sesame oil, medium-chain fatty acid-containing triglycerides (MCT), shea butter, and sal fat. The raw material oil and/or fat may also be a product obtained by subjecting one or more oils and/or fats selected from the examples above to one or more processes selected from fractionation, hydrogenation, and interesterification.

In particular, palm oil, fractionated palm oil, high oleic sunflower oil, and fully hydrogenated high erucic rapeseed oil can be preferably used.

The random interesterification mentioned above may be carried out by a method using a chemical catalyst or a method using an enzyme catalyst. The chemical catalyst may be, for example, an alkali metal catalyst such as sodium methylate. The enzyme catalyst may be, for example, lipases of the genus Alcaligenes, the genus Penicillium, or the genus Thermomyces. These lipases may be used after being immobilized on an ion-exchange resin, diatomaceous earth, or the like by a known method, or may be used in the form of a powder.

The fractionation operation mentioned above may be carried out by a method such as solvent fractionation or non-solvent fractionation, whereby an oil and/or fat of a low melting point fraction or a medium melting point fraction can be produced.

Optional components commonly used in chocolate such as a coloring agent, an emulsifier, an antioxidant, and a flavoring can be added to the oil and/or fat for chocolate according to an embodiment of the present invention as appropriate. These optional components are in an amount of 20 wt. % or less, and preferably 10 wt. % or less, with respect to the oil and/or fat for chocolate according to an embodiment of the present invention.

Examples of the emulsifier mentioned above include a glycerol fatty acid ester, a sucrose fatty acid ester, a sorbitan fatty acid ester, a glycerol organic acid fatty acid ester, a polyglycerol fatty acid ester, and lecithin.

An amount of the oil and/or fat for chocolate according to an embodiment of the present invention to be used is preferably from 10 to 65 mass %, more preferably from 10 to 50 mass %, and even more preferably from 15 to 45 mass % with respect to the entire chocolate.

The oil and/or fat for chocolate according to an embodiment of the present invention produced as described above can be used alone or in combination with cacao butter as an oil and/or fat for chocolate, and can be used to produce chocolate without a tempering treatment. It should be noted that the “chocolate” referred to herein is not limited by regulations (“Fair Regulations for Labeling of Chocolate”) or legal provisions, and includes various types of chocolate such as sweet chocolate, milk chocolate, white chocolate, and colored chocolate such as strawberry chocolate.

### Examples

Examples will be described below, but the technical idea of the present invention is not limited to these examples. In the examples, “part” and “%” both express values based on weight.

### Measurement Method of Fatty Acid Composition

The constituent fatty acid compositions of oils and/or fats were determined according to Standard Methods for the Analysis of Fats, Oils and Related Material 2.4.2.1-2013.

### Measurement Method of Triglyceride Composition

The triglyceride compositions were measured by high performance liquid chromatography according to Standard Methods for the Analysis of Fats, Oils and Related Material 2.4.6.2-2013.

### Measurement Method of Solid Fat Content

The analyzer used was “minispec mq20” available from Bruker Corporation. The solid fat contents in Table 6 were determined according to IUPAC 2.150a (Solid Content Determination in Fats by NMR).

Preparation of Oil and/or Fat A

An oil blend containing 45 wt. % of palm oil (iodine value: 52.5), 35 wt. % of a BOB fat, 15 wt. % of fully hydrogenated high erucic rapeseed oil, and 5 wt. % of a high melting point fraction of palm oil (iodine value: 31.0) was subjected to random interesterification with sodium methylate, resulting in a interesterified oil and/or fat. The high melting point fraction and the low melting point fraction were removed from the interesterified oil and/or fat by hexane fractionation, resulting in an oil and/or fat A. The fatty acid compositions of the interesterified oil and oil and/or fat A are presented in Table 2.

The BOB fat is a fat containing 66% of BOB triglycerides obtained by interesterifying high oleic sunflower oil and behenic acid with a 1, 3-specific lipase to produce an oil and/or fat and then subjecting the resulting oil and/or fat to fractionation and concentration using hexane. (B is behenic acid and O is oleic acid)

Preparation of Oil and/or Fat for Chocolate

The oil and/or fat A, BOB fat, fully hydrogenated high erucic rapeseed oil, and “Melano NT-R”, which is an existing non-lauric, non-trans, and non-tempering oil and/or fat for chocolate available from Fuji Oil Co., Ltd., were blended in accordance with the proportions presented in Table 1, resulting in oils and/or fats of Examples 1 to 3 and Comparative Examples 1 to 6. The fatty acid compositions of each of the oils and fats as well as Examples 1 to 3 and Comparative Examples 1 to 6 are presented in Table 2, and the triglyceride compositions thereof are presented in Table 3.

The above-mentioned Melano NT-R is a non-tempering oil and/or fat for chocolate composed of the medium melting point fraction of a random interesterified oil and/or fat made only from a non-lauric oil and/or fat containing a palm-based oil and/or fat as the main component.

TABLE 1
Oil and/or Fat Blended

| | Oil and/or Fat Blended | | | |
|---|---|---|---|---|
| | | | | Fully |
| | | Oil | | Hydrogenated |
| | Melano | and/or | BOB | High Erucic |
| | NT-R | Fat A | Fat | Rapeseed Oil |
| Example 1 | 91.0 | 9.0 | | |
| Example 2 | 85.0 | 15.0 | | |
| Example 3 | 75.0 | 25.0 | | |
| Comparative Example 1 | 100.0 | | | |
| Comparative Example 2 | 95.5 | 4.5 | | |
| Comparative Example 3 | 98.0 | | 2.0 | |
| Comparative Example 4 | 96.0 | | 4.0 | |
| Comparative Example 5 | 90.0 | | 10.0 | |
| Comparative Example 6 | 97.5 | | | 2.5 |

TABLE 2
Fatty Acid Composition

| | | | | | | | | | | | | Trans |
|---|---|---|---|---|---|---|---|---|---|---|---|---|
| | | | | | | | | | | | | Fatty |
| | C12 | C14 | C16 | C18 | C18F1 | C18F2 | C18F3 | C20 | C20F1 | C22 | C24 | Acids |
| Interesterified oil | 0.1 | 0.5 | 24.0 | 9.0 | 29.1 | 5 | 0.0 | 3.1 | 0.0 | 28.3 | 0.7 | 0.6 |
| Oil and/or Fat A | 0.1 | 0.5 | 24.0 | 9.2 | 28.8 | 4.7 | 0.0 | 3.1 | 0.0 | 29.6 | 0.0 | 0.6 |
| Melano NT-R | 0.1 | 0.9 | 50.9 | 14.8 | 28.4 | 4.4 | 0.4 | 0.0 | 0.0 | 0.0 | 0.0 | 0.6 |
| BOB Fat | 0.0 | 0.0 | 0.4 | 2.8 | 26.5 | 0.6 | 0.1 | 5.8 | 0.0 | 63.8 | 0.0 | 1.3 |
| Fully Hydrogenated High | 0.0 | 0.0 | 3.9 | 40.0 | 0.0 | 0.0 | 0.0 | 8.5 | 0.0 | 46.7 | 0.9 | 0.0 |
| Erucic Rapeseed Oil | | | | | | | | | | | | |
| Example 1 | 0.1 | 0.9 | 48.5 | 14.3 | 28.4 | 4.4 | 0.4 | 0.3 | 0.0 | 2.7 | 0.0 | 0.6 |
| Example 2 | 0.1 | 0.9 | 46.9 | 14.0 | 28.4 | 4.4 | 0.4 | 0.5 | 0.0 | 4.4 | 0.0 | 0.6 |
| Example 3 | 0.1 | 0.8 | 44.2 | 13.4 | 28.5 | 4.5 | 0.3 | 0.8 | 0.0 | 7.4 | 0.0 | 0.6 |
| Comparative Example 1 | 0.1 | 0.9 | 50.9 | 14.8 | 28.4 | 4.4 | 0.4 | 0.0 | 0.0 | 0.0 | 0.0 | 0.6 |
| Comparative Example 2 | 0.1 | 0.9 | 49.7 | 14.6 | 28.4 | 4.4 | 0.4 | 0.1 | 0.0 | 1.3 | 0.0 | 0.6 |
| Comparative Example 3 | 0.1 | 0.9 | 49.9 | 14.6 | 28.3 | 4.3 | 0.4 | 0.1 | 0.0 | 1.3 | 0.0 | 0.6 |
| Comparative Example 4 | 0.1 | 0.9 | 48.9 | 14.3 | 28.3 | 4.2 | 0.4 | 0.2 | 0.0 | 2.6 | 0.0 | 0.6 |
| Comparative Example 5 | 0.1 | 0.8 | 45.8 | 13.6 | 28.2 | 4.0 | 0.4 | 0.6 | 0.0 | 6.4 | 0.0 | 0.7 |
| Comparative Example 6 | 0.1 | 0.9 | 49.7 | 15.5 | 27.7 | 4.3 | 0.4 | 0.2 | 0.0 | 1.2 | 0.0 | 0.6 |

TABLE 3
Triglyceride Composition

| | | | | | | Proportion of | | |
|---|---|---|---|---|---|---|---|---|
| | | | | | | the Total of | | |
| | | | | | | BSU and B2U | Tri-saturated | |
| | | | | | | in B-bound | Fatty Acid | |
| | S2U | SSU/S2U | BSU | B2U | BSU/B2U | Triglycerides | Triglycerides | BPU/BStU |
| Example 1 | 70.0 | 0.7 | 3.0 | 1.0 | 2.9 | 0.7 | 12.1 | 2.9 |
| Example 2 | 66.6 | 0.7 | 4.9 | 1.7 | 2.9 | 0.7 | 12.1 | 2.9 |
| Example 3 | 60.9 | 0.7 | 8.2 | 2.9 | 2.9 | 0.8 | 12.1 | 2.9 |
| Comparative | 75.1 | 0.7 | 0.0 | 0.0 | — | 0.0 | 12.1 | |
| Example 1 | | | | | | | | |
| Comparative | 72.5 | 0.7 | 1.5 | 0.5 | 2.9 | 0.7 | 12.1 | |
| Example 2 | | | | | | | | |
| Comparative | 73.6 | 0.7 | 0.4 | 1.4 | 0.3 | 0.7 | 11.9 | |
| Example 3 | | | | | | | | |
| Comparative | 72.1 | 0.7 | 0.7 | 2.7 | 0.3 | 0.8 | 11.7 | |
| Example 4 | | | | | | | | |
| Comparative | 67.6 | 0.7 | 1.8 | 6.8 | 0.3 | 0.9 | 11.1 | |
| Example 5 | | | | | | | | |
| Comparative | 73.2 | 0.7 | 0.0 | 0.0 | — | 0.0 | 14.2 | |
| Example 6 | | | | | | | | |

### Production of Chocolate

32 parts of each oil and/or fat of Examples 1 to 3 and Comparative Examples 1 to 6, 4 parts of cocoa butter, 44 parts of powdered sugar, 16 parts of cocoa powder, 4 parts of cacao mass, and 0.4 parts of lecithin were blended to produce a chocolate mix (having an oil and/or fat content of 40.0 wt. %) by a commonly used method. Then, the chocolate mix was filled into an aluminum cup at a product temperature of 45° C. and cooled to 15° C. for 30 minutes. Thereafter, the resulting products were aged at 20° C. for one week and subjected to a blooming resistance test.

### Blooming Resistance Test

The occurrence of blooming on the surface of chocolate over time was examined under a condition of a cycle going between 17° C. and 28° C. in one day (8 hours of 17° C., 4 hours of temperature rise, 8 hours of 28° C., and 4 hours of temperature decrease) and under a condition of constant temperature at 17° C. The results are presented in Table 4.

### Evaluation Criteria of Blooming

0 Point No occurrence of blooming
1 Point Slightly lacking in shine from certain viewing angles
2 Points No shine from certain viewing angles
3 Points No shine from all viewing angles
4 Points No shine from all viewing angles, and slight change in color
5 Points No shine from all viewing angles, and change in color

### Blooming Resistance Test Results

Blooming occurred on day 88 in Comparative Example 1 which was NT-CBR. In comparison, blooming did not occur for at least 122 days in the chocolates using the oils and/or fats of Examples 1 to 3, indicating excellent blooming resistance. Whereas, in Comparative Examples 2, 3, and 6, blooming occurred from day 88 to day 102 onward, making them inferior.

Furthermore, in Comparative Examples 4 and 5, blooming occurred in only 18 days, which is problematic.

TABLE 4
Blooming Test Results

| 17-28° C. | Day 0 | Day 18 | Day 38 | Day 52 | Day 60 | Day 88 | Day 102 | Day 122 |
|---|---|---|---|---|---|---|---|---|
| Example 1 | 0 | 0 | 0 | 0 | 0 | 0 | 0 | 0 |
| Example 2 | 0 | 0 | 0 | 0 | 0 | 0 | 0 | 0 |
| Example 3 | 0 | 0 | 0 | 0 | 0 | 0 | 0 | 0 |
| Comparative | 0 | 0 | 0 | 0 | 0 | 4 | 5 | 5 |
| Example 1 | | | | | | | | |
| Comparative | 0 | 0 | 0 | 0 | 0 | 0 | 2 | 3 |
| Example 2 | | | | | | | | |
| Comparative | 0 | 0 | 0 | 0 | 0 | 0 | 1 | 5 |
| Example 3 | | | | | | | | |
| Comparative | 0 | 3 | 3 | 3 | 3 | 3 | 4 | 5 |
| Example 4 | | | | | | | | |
| Comparative | 0 | 4 | 4 | 4 | 4 | 5 | 5 | 5 |
| Example 5 | | | | | | | | |
| Comparative | 0 | 0 | 0 | 0 | 0 | 3 | 5 | 5 |
| Example 6 | | | | | | | | |

Solidification Speed of Oil and/or Fat

After being confirmed to have a certain level of blooming resistance during the blooming resistance test, Examples 1 to 3 and Comparative Examples 2, 3, and 6 were subjected to a comparison of solidification speed of oil and/or fat.

The oils and/or fats of Examples and Comparative Examples were each mixed with cocoa butter at a ratio of 80/20 according to the ratio in the oil content of chocolate, resulting in an oil and/or fat. The solid fat content of the resulting oil and/or fat after cooling at 15° C. for 30 minutes was determined by the following method and used as an indicator of the solidification speed. The results are presented in Table 5.
Keeping the oil and/or fat at 80° C. for 10 minutes and then keeping it at 60° C. for 30 minutes to completely melt the oil and/or fat
Keeping the oil and/or fat at 15° C. for 30 minutes and using the solid fat content at the time as the solid fat content after cooling to 15° C. for 30 minutes.

TABLE 5
Solidification Speed

| | Solid Fat Content After Cooling to |
|---|---|
| | 15° C. for 30 Minutes |
| Example 1 | 41 |
| Example 2 | 47 |
| Example 3 | 50 |
| Comparative Example 2 | 38 |
| Comparative Example 3 | 38 |
| Comparative Example 6 | 36 |

Results of Measurement of Solidification Speed of Oil and/or Fat

The solid fat contents after cooling to 15° C. for 30 minutes in Examples 1 to 3 are higher than those in Comparative Examples 2, 3, and 6. As such, Examples 1 to 3 are superior to Comparative Examples 2, 3, and 6 in terms of the solidification speed.

TABLE 6
Solid Fat Content

| | 10° C. | 20° C. | 25° C. | 30° C. | 35° C. | 40° C. |
|---|---|---|---|---|---|---|
| Example 1 | 88.3 | 71.7 | 50.4 | 30.1 | 14.9 | 4.2 |
| Example 2 | 88.1 | 70.6 | 49.6 | 28.8 | 14.3 | 3.4 |
| Example 3 | 87.1 | 69.9 | 48.6 | 28.7 | 12.9 | 1.8 |
| Comparative | 89.6 | 74.3 | 54.3 | 32.1 | 16.6 | 5.5 |
| Example 1 | | | | | | |
| Comparative | 88.9 | 72.9 | 52.3 | 31.1 | 15.7 | 4.6 |
| Example 2 | | | | | | |
| Comparative | 89.0 | 72.4 | 52.1 | 30.9 | 15.8 | 4.9 |
| Example 3 | | | | | | |
| Comparative | 88.8 | 71.1 | 50.5 | 29.9 | 15.2 | 4.5 |
| Example 4 | | | | | | |
| Comparative | 88.1 | 71.0 | 50.5 | 28.6 | 13.3 | 3.5 |
| Example 5 | | | | | | |
| Comparative | 89.5 | 74.7 | 56.1 | 34.7 | 17.8 | 5.5 |
| Example 6 | | | | | | |

### INDUSTRIAL APPLICABILITY

According to the present invention, it is possible to provide a non-lauric, non-trans, and non-tempering chocolate having excellent blooming resistance and solidification speed.

1. A non-lauric, non-trans, and non-tempering oil and/or fat for chocolate, the oil and/or fat satisfying all of the following conditions:
a S2U triglyceride content being from 50 to 85 wt. %;
a proportion of SSU triglycerides in S2U triglycerides being from 0.3 to 0.7;
a BSU triglyceride content being from 2 to 15 wt. %;
a ratio of BSU triglycerides to B2U triglycerides (BSU/B2U) being 1 or greater;
a proportion of a total of BSU and B2U triglycerides in a total of B-bound triglycerides being 0.5 or greater;
where “S” means a saturated fatty acid having from 16 to 20 carbons, “U” means an unsaturated fatty acid having from 16 to 20 carbons, “B” means behenic acid, and
“S2U” means a triglyceride bound with two Ss and one U, “SSU” means a triglyceride with S bound at the 2-position and S and U bound at the 1- and 3-positions, “BSU” means a triglyceride bound with one B, one S, and one U, “B2U” means a triglyceride bound with two Bs and one U, and “B-bound triglyceride” means a triglyceride bound with at least one B.

2. The oil and/or fat for chocolate according to claim 1, wherein a ratio of BPU triglycerides to BStU triglycerides (BPU/BStU) is 1.5 or greater, where “P” means palmitic acid, “St” means stearic acid, and
“BPU” means a triglyceride bound with one B, one P, and one U, and “BStU” means a triglyceride bound with one B, one St, and one U.

3. The oil and/or fat for chocolate according to claim 1, comprising from 4 to 20 wt. % of tri-saturated triglycerides.

4. The oil and/or fat for chocolate according to claim 2, comprising from 4 to 20 wt. % of tri-saturated triglycerides.

5. The oil and/or fat for chocolate according to claim 1, wherein a solid fat content at 20° C. is from 60 to 80%, and a solid fat content at 40° C. is 10% or less.

6. The oil and/or fat for chocolate according to claim 1, wherein the oil and/or fat for chocolate is used in chocolate for coating purposes.

7. The oil and/or fat for chocolate according to claim 5, wherein the oil and/or fat for chocolate is used in chocolate for coating purposes.

8. A chocolate comprising the oil and/or fat for chocolate described in claim 1.

9. A chocolate comprising the oil and/or fat for chocolate described in claim 5.

10. A coating chocolate comprising the oil and/or fat for chocolate described in claim 1.

11. A coating chocolate comprising the oil and/or fat for chocolate described in claim 5.

12. The oil and/or fat for chocolate according to claim 2, wherein a solid fat content at 20° C. is from 60 to 80%, and a solid fat content at 40° C. is 10% or less.

13. The oil and/or fat for chocolate according to claim 3, wherein a solid fat content at 20° C. is from 60 to 80%, and a solid fat content at 40° C. is 10% or less.

14. The oil and/or fat for chocolate according to claim 4, wherein a solid fat content at 20° C. is from 60 to 80%, and a solid fat content at 40° C. is 10% or less.

15. The oil and/or fat for chocolate according to claim 2, wherein the oil and/or fat for chocolate is used in chocolate for coating purposes.

16. The oil and/or fat for chocolate according to claim 3, wherein the oil and/or fat for chocolate is used in chocolate for coating purposes.

17. The oil and/or fat for chocolate according to claim 4, wherein the oil and/or fat for chocolate is used in chocolate for coating purposes.

18. A chocolate comprising the oil and/or fat for chocolate described in claim 2.

19. A chocolate comprising the oil and/or fat for chocolate described in claim 3.

20. A coating chocolate comprising the oil and/or fat for chocolate claim 2.
